(19) United States
(12) Patent Application Publication
(10) Pub. No.: US 2023/0372837 A1
(43) Pub. Date: Nov. 23, 2023

(54) SYSTEMS AND METHODS FOR EVAPORATION AND CONDENSATION WITH VAPOR RECOMPRESSION

(71) Applicant: ROCHEM SEPARATION SYSTEM INDIA (P) LTD., Maharashtra (IN)

(72) Inventor: Prayas GOEL, Maharashtra (IN)

(21) Appl. No.: 18/030,913

(22) PCT Filed: Oct. 8, 2021
(86) PCT No.: PCT/IN2021/050969

§ 371 Date: Apr. 7, 2023

(30) Foreign Application Priority Data
Oct. 8, 2020 (IN) 202021043779

(51) Int. Cl. B01D 1/26; B01D 1/28

(52) U.S. Cl. CPC B01D 1/26; B01D 1/28

(57) ABSTRACT

According to the present disclosure, a system and method for evaporation and condensation are disclosed. The system (1) comprises at least one evaporation-condensation unit (2) comprising a plurality of frames arranged in a series of stacks, each stack comprises an evaporation frame (9) and a condensation frame (5) separated by a polymer sheet (6). The unit (2) receives a feed (3) and a part of the feed (3) partially evaporates within the unit (2) and generates vapor (4). The system further comprises a mechanical vapor recompressor (8) mounted outside the unit (2) receiving the generated vapor from the unit (2) at a vapor outlet. Each frame is made of a polymer material and a plurality of frames are detachably integrated within the unit thereby forming a modular system. A multi-effect system for evaporation and condensation is formed by arranging at least two evaporation-condensation units in series with a recompressor (8).

### TECHNICAL FIELD

The present disclosure generally relates to evaporation and condensation systems and methods, and more particularly to a system and method for evaporation and compression with a novel configuration having polymer films driven by a mechanical vapor recompressor unit.

### BACKGROUND

Treatment of contaminated solvents such as effluent water to employ evaporation and condensation stages in an effort to remove solutes is well known in the art using a variety of systems and methods. However, conventional solvent treatment systems generally lack the ability to process a broad range of effluent produced from common industrial practices. The present solutions and systems are aiming to reduce the amount of wastewater, achieve zero liquid discharge and also to make wastewater mining possible solutions.

Systems for distilling water such as large boilers are well known to encounter scaling and maintenance issues, and moreover require a large amount of additional energy to bring the solvent to a vapor phase. Vacuum or high pressure systems must be designed to safely contain the processes and require additional turbo-machinery, which significantly increases costs. Industrial waste solutions most often do not have a neutral pH-value. Hence, zero-liquid discharge systems typically use high-cost high grade steel or titanium to prevent corrosion in the high-pressure, high-temperature environments employed. In some alternate solutions, the pH value is brought to neutral, however resulting to generate an additional waste load, salt. So, the target and solution is to identify and use materials that work over the whole range of pH values from very low, acidic, to very high, base.

Many prior art systems have been developed to process contaminated solvent using vapor compression systems. In one system, a plurality of membranes are used. It was found out that the use of membranes limits the number of possible applications because there is a risk of wetting. Wastewater even industrial waste water is never exactly defined and often contain oil and surfactants. Oil and surfactants destroy the needed hydrophobicity that causes wetting of the membrane and leakages. Also scaling and crystallization on the membrane can cause wetting. In some systems, membranes made from organic polymers or compounds are used and they are susceptible to corrosion, therefore limiting their ability to process tailings from oil, gas or mining operations or chemical waste products.

Most of the conventional systems and solutions are constructed from expensive stainless steel (SS) having high costs. Even with stainless steel of exotic grades, these are prone to corrosion related failures. Stainless Steel construction eliminates the possibility of use with extreme pH applications. Some polymeric systems utilize Membranes. As said above, such membranes are prone to wetting related failures to scaling or exposure to wetting agents such as oil, surfactants and other low surface tension fluids. Further, such polymer systems utilize welding technologies to combine vessel that leads to encounter difficulties when the system requires a maintenance, cleaning or replacement of materials or frames.

Hence, there is a need for a novel integrated modular system for evaporation and condensation driven by mechanical vapor recompression that can be assembled and disassembled when required and preferably achieving desirable efficiencies at a lower cost than most conventional systems.

### OBJECT OF THE INVENTION

It is the primary object of the present disclosure to provide a system for evaporation and condensation driven by a mechanical vapor recompression unit.

It is another object of the present disclosure to provide a modular system for evaporation and condensation constructed with polymeric materials.

It is still another object of the present disclosure to provide a method for evaporation and condensation.

### SUMMARY

In an aspect of the present disclosure, a system for evaporation and condensation is disclosed. The system comprises at least one evaporation-condensation unit comprising a plurality of frames arranged in a series of stacks, each stack comprises an evaporation frame and a condensation frame separated by a polymer sheet. The evaporation-condensation unit is a partially flooded sealed unit comprising a lower inlet, a vapor outlet, a concentrate outlet, an upper inlet and a distillate outlet. The unit receives a feed at the lower inlet and a part of the feed partially evaporates at the evaporation frame and generates vapor. The system further comprises a mechanical vapor recompressor mounted outside the at least one evaporation-condensation unit receiving the generated vapor from the at least one evaporation-condensation unit at a vapor outlet and feeding back the vapor with high pressure and temperature to the evaporation-condensation unit at an upper inlet. Each frame is made of a polymer material and a plurality of frames are detachably integrated within the evaporation-condensation unit thereby forming a modular system for evaporation and condensation. The series of stacks may be arranged in a repeated pattern or an alternative pattern of frames.

In another aspect of the present disclosure, a method for evaporation and condensation is disclosed. The method comprises of passing a feed through at least one evaporation-condensation unit at a lower inlet. The evaporation-condensation unit comprises a plurality of frames arranged in a series of stacks or a plurality of stacks, each stack comprises an evaporation frame and a condensation frame separated by a polymer sheet. The method further comprises of distributing the feed to the evaporation frames of the evaporation-condensation unit, partially evaporating a part of the feed at the evaporation frames within the unit and generating vapor, passing the generated vapor at a vapor outlet to a mechanical vapor recompressor mounted outside the evaporation-condensation unit for compression and feeding back the compressed vapor with the high pressure and temperature at an upper inlet of the evaporation-condensation unit from the mechanical vapor recompressor. The method further comprises of passing the compressed vapor to condensation frames separated by the polymer sheet from evaporation frames and the mechanical vapor recompressor for condensation, forming a distillate and concentrate by condensing the compressed vapor at the condensation frames placed opposite to the evaporation frames and collecting the distillate from the evaporation-condensation unit at a distillate outlet and the concentrate from the evaporation-condensation unit at a concentrate outlet. Each frame is made of a polymer material and a plurality of frames are detachably integrated within the evaporation-condensation unit.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1, illustrates a Mechanical Vapor Recompression (MVR) system for evaporation and condensation in accordance with an exemplary embodiment of the present disclosure.

FIG. 2, illustrates a Mechanical Vapor Recompression (MVR) system combined with a heat recovery unit.

FIG. 3, illustrates a Mechanical Vapor Recompression (MVR) system with an additional droplet separator.

FIG. 4, illustrates a multi-effect Mechanical Vapor Recompression (MVR) system with two evaporation-condensation units.

### DETAILED DESCRIPTION OF THE INVENTION

In the present invention, a system and method for evaporation and condensation are disclosed. The present invention discloses a modular system with Mechanical Vapor recompressions and constructed with Polymeric materials for the modularity. Each individual frame/chamber is separated by a polymer film or a microporous, hydrophobic membrane. Each individual frame provides thermal insulation and separation between the other frame/chamber. Frames are detachably combined together and form a stack of frames for evaporation and condensation, so that maintenance, cleaning and replacement of frames are much easier than the conventional system having welded frames.

In an embodiment of the present disclosure, a system for evaporation and condensation is disclosed. The system may comprise an evaporation-condensation unit and a mechanical vapor recompressor (MVR). The evaporation-condensation unit comprises a plurality of frames enclosed/integrated in a pressure tight sealed unit. The plurality of frames detachably integrated within the evaporation-condensation unit. These frames may be used for different functionalities. For example, the frames are used for evaporation, condensation and droplet separation. In some embodiments of the present invention, the frames are used for preheating a feed. Two or more frames are combined and arranged to form a set of frames or a ‘stack’ of frames.

The evaporation-condensation unit comprises a plurality of stacks, that may be combinedly arranged in series or in an alternative manner. The plurality of frames may be arranged in a repeated pattern and separated by polymer films. In some embodiments, a series of stacks or a plurality of stacks may be arranged in a repeated pattern or an alternative pattern of plurality of frames. In one example of the present disclosure, a frame pattern or combination may include an evaporation frame and a condensation frame separated by a polymer film or sheet. The mechanical vapor recompressor (MVR) is mounted externally to the evaporation-condensation unit. In some embodiments, the mechanical vapor recompressor (MVR) is detachably integrated with the evaporation-condensation unit.

Each frame comprises an outer segment/framework, an intermediate segment and an inner segment. The outer segment of the frame provides thermal separation, ambient-to interior temperature and mechanical stability, ambient-to interior pressure of the system. The intermediate segment comprises multiple flow channels, openings and orifices for feed, brine, distillate and vapor. The Inner segment comprises a functional area used for the functionalities such as for evaporation, condensation and pre-heating. The plurality of frames are separated polymer films in such a way that each frame is separated from other frame by a polymer film or sheet that covers the functional area of each frame.

Each frame is made of a polymer and can be made using injection molding process or any other suitable industrial methods. As polymers are used, these frames are chemically stable against the treated fluid. In one embodiment of the present disclosure, a Polyvinylidene fluoride (PVDF) material is a used as a frame material for high temperature and aggressive fluid applications. Further, the polymer sheet separation is made of a material selected from Polypropylene (PP), Polyvinyl chloride (PVC) or Polyvinylidene fluoride (PVDF). The polymer sheet has a thickness ranging from 10 μm to 40 μm.

In an exemplary embodiment of the present disclosure, a modular frame as disclosed in the Indian Patent Application No. 202021043600, and the like, is used and incorporated in its entirety herewith. The plurality of frames can be readily removed for cleaning and/or maintenance and easily reinstalled after such cleaning or maintenance. Thus, the arrangement of frames and stacks can be assembled or dismantled for cleaning, maintenance and replacement of frames, if any. The present disclosure provides a significant advantage over conventional MVR systems that require more extensive efforts to install and/or remove frames in terms of both (1) the time and effort required to clean and/or maintain frames; and (2) the accompanying disincentive to actually clean the unit on a regular basis.

The evaporation-condensation unit comprises an at least partially flooded/submerged evaporator channel/frame. The channel fluid boils due to the operational pressure of the unit. The evaporation pressure is the boiling pressure of the fluid as absolute pressure reduced by the pressure caused by the water column of the fluid. If the absolute pressure is reduced, the solution/fluid in the evaporation frame boils over the whole filling height.

In some embodiments of the disclosure, the system may further comprise a plurality of heat exchangers coupled with the evaporation-condensation unit. The plurality of heat exchangers are placed outside the evaporation-condensation unit. In some other embodiments, the plurality of heat exchangers are detachably integrated with the evaporation-condensation unit. The heat exchangers are used for different purposes. In one example, heat exchangers are used to transfer heat from the concentrate to the feed. In another example, heat exchangers are used to transfer heat from the distillate to the feed and sometimes, heat exchangers may be used as preheaters to preheat the feed during the start up. In such cases, heat exchangers may be integrated with the evaporation-condensation unit and used for startup.

In some embodiments of the disclosure, the system may further comprise a droplet separator detachably attached to the evaporation-condensation unit. The droplet separator comprise a stack of plurality of frames separated by multiple membranes. In some other embodiments of the disclosure, the droplet separator is detachably integrated within the evaporation-condensation unit. The evaporation-condensation unit comprise a plurality of stacks. The plurality of stacks comprise evaporation frames and condensation frames separated by polymer films, and a stack of frames separated by membranes forming the droplet separator. In the droplet separator, each individual frame/chamber is separated by a microporous hydrophobic membrane. In this system, the mechanical vapor recompressor (MVR) is connected with the integrated droplet separator, receiving droplet free vapor for further compression and condensation. The droplets are separated and hold back by the microporous hydrophobic membranes. The separated droplets are collected by the stack of frames and leave at an outlet of the evaporation-condensation unit.

In some other embodiments of the disclosure, the system may comprise two or more evaporation-condensation units arranged in series with a mechanical vapor recompressor (MVR) and form a multi stage/multi-effect MVR system. In such multi stage systems, multiple evaporation-condensation units operate at different pressure levels and temperatures. Thus, each unit operate at a different pressure and temperature to its adjacent or next unit. In some other embodiments of the disclosure, two or more evaporation-condensation units are integrally mounted in series within a sealed unit forming a multi-effect system for evaporation and condensation. The integrated evaporation-condensation units are separated by a polymer frame comprising a plurality of orifices for the flow of condensate and feed respectively from one evaporation-condensation unit to another evaporation-condensation unit.

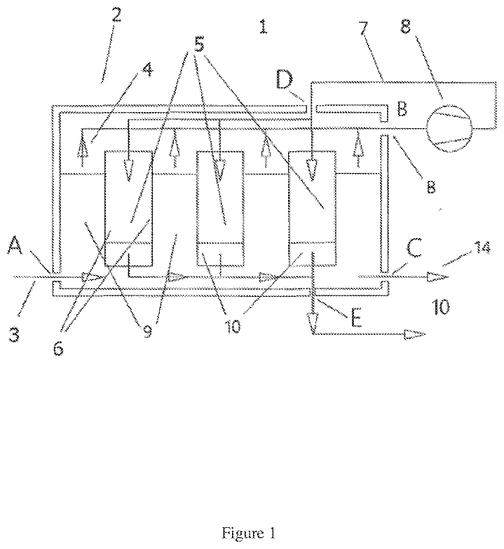

Referring to FIG. 1, illustrates a Mechanical Vapor Recompression (MVR) system (1) for evaporation and condensation in accordance with an exemplary embodiment of the present disclosure. The MVR system (1) comprises an evaporation-condensation unit (2) and a mechanical vapor recompressor (MVR) (8). A feed (3) enters the evaporation-condensation unit (2) at a lower inlet (A) and the feed is distributed to the frames for evaporation (9). The feed may be brine, brackish water, waste water or any other fluid feed. A part of the feed (3) evaporates within the unit (2) and forms vapor (4). The vapor (4) leaves the unit (2) and flows to the suction side of the recompressor (8). The compressed vapor (7) leaves the compressor (8) at a vapor outlet B with a higher pressure and temperature, and enters back at unit (2) at an upper inlet (D), particularly the compressed vapor (7) enters frames separated by the polymer film/sheet from the suction side of the recompressor. The compressed vapor condenses on the opposite side of the evaporation and the heat of condensation is transferred to the solution in the evaporation frame. Within the unit (2), the compressed vapor (7) enters the frames for condensation (5) and condenses on the film for condensation (6) by forming the distillate (10). The distillate (10) leaves the unit (2) and can be collected at a distillate outlet (E) and the concentrate (14) leaves the unit (2) at a concentrate outlet (C).

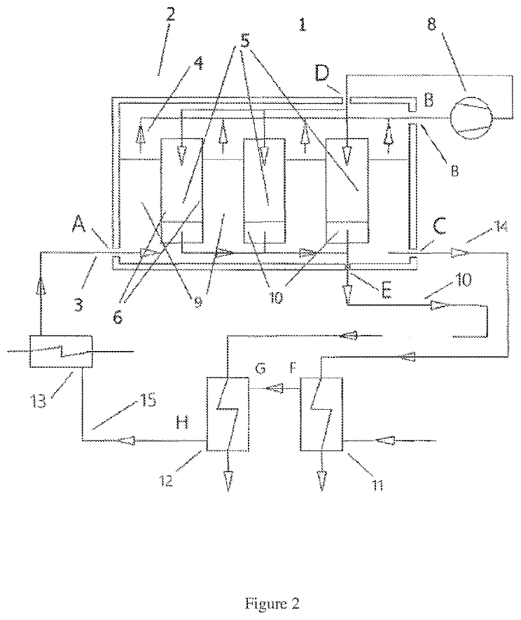

Referring to FIG. 2, illustrates a Mechanical Vapor Recompression (MVR) system combined with a heat recovery unit. The heat recovery unit comprises a plurality of heat exchangers. The plurality of heat exchangers comprise a first heat exchanger (11) mounted at the concentrate outlet (C), a second heat exchanger (12) mounted at the distillate outlet (E) and a third heat exchanger (13) mounted with the lower inlet (A). At the first heat exchanger (11), heat from the concentrate (14) is transferred to the feed (3). The feed (3) leaves the first heat exchanger (11) at F and enters the second heat exchanger (12) at G. At the second heat exchanger (12), the feed (3) is further heated by heat transferred from the distillate (10). The feed (3) leaves the second heat exchanger (12) at H. In the feed/solution line (15), a third heat exchanger (13) is integrated for the startup phase. The third heat exchanger (13) is used for heating the feed during startup or to heat the feed (3) further.

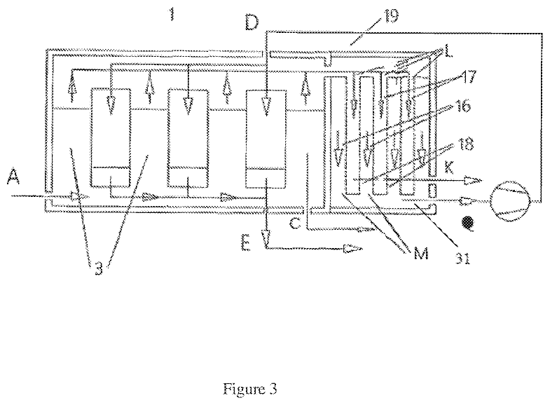

Referring to FIG. 3, illustrates a Mechanical Vapor Recompression (MVR) system (1) with an additional droplet separator (19). The droplet separator (19) is built out of membrane frames/chambers. The droplet separator (19) is detachably attached with the evaporation-condensation unit (2). These frames are separated by membranes (18). The droplet separator (19) comprises droplet separation frames (17), clean vapor frame (16) and the microporous hydrophobic membranes (18). The droplet separator (19) receives vapor (4) from the evaporation-condensation unit (2). The droplet separator (19) has a vapor inlet (L) for the vapor to enter into the separation frames (7) and membranes. The Vapor (4) enters with droplets in the droplet separation frames (17) at L. The vapor (4) passes through the microporous, hydrophobic membranes (18) and flows into the clean vapor frame (16) and leaves the clean vapor frame (16) at M. The droplet free vapor (31) now leaves the droplet separator at Q. The droplet free vapor (31) flows to the suction side of the recompressor (8). The droplets hold back by the microporous hydrophobic membranes (18) are collected in the droplet separator frames (17). The separated droplets leave the droplet separator (19) at an outlet K.

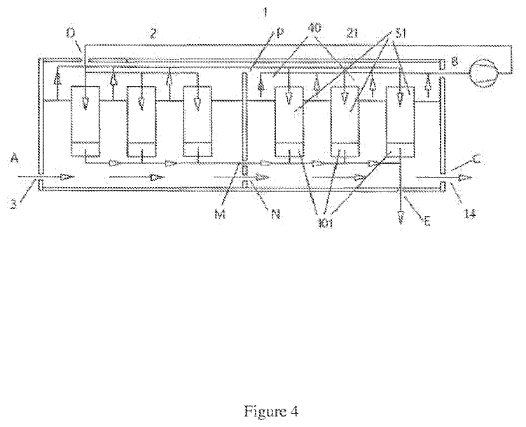

Referring to FIG. 4, illustrates a multi-effect Mechanical Vapor Recompression (MVR) system with two evaporation-condensation units (2) and (21). The two evaporation-condensation units (2), (21) work at different temperatures and pressures. Temperature and pressure are higher in the evaporation-condensation unit (2) than in the evaporation-condensation unit (21). Alternatively, in some embodiments, the temperature and pressure may be higher in the evaporation-condensation unit (21) than in the evaporation-condensation unit (2). The feed (3) enters the multi-effect MVR-system, evaporation-condensation unit (2) at the lower inlet (A). In the evaporation-condensation unit (2), the feed (3) is concentrated by creating vapor (4). The vapor (4) leaves evaporation-condensation unit (2) at P and flows into the condensation frames/chambers (51) for condensation. The vapor (4) condenses and forms the condensate (101).

The condensate (10) flows via the orifice M to the evaporation-condensation unit (21). The concentrated solution/feed (3) flows via the orifice N to the evaporation-condensation unit (21). Due to lower pressure and temperature the condensate (10) and the solution (3) are flashing by entering the evaporation-condensation unit (21). A part of solution (3) evaporates within the unit (21) and produces vapor (40). The produced vapor (40) leaves the evaporation-condensation unit (21) at B and flows to the suction side of the compressor (8). At the compressor (8), the vapor (40) is compressed with a higher temperature and pressure and compressed vapor (41) is generated. After the compressor, the compressed vapor (41) enters the evaporation-condensation unit (2) at the upper inlet D. The condensates (10) and (101) leave the evaporation-condensation unit (21) at the distillate/condensate outlet (E), the concentrated solution (14) leaves the evaporation-condensation unit (21) at the concentrate outlet (C).

In another embodiment of the present disclosure, a method for evaporation and condensation is disclosed. The method uses a novel configuration of Mechanical Vapour recompression with polymeric films. The method comprises of passing a feed/solution through a plurality of frames of an evaporation-condensation unit, distributing the feed to the evaporation frames (9) of the evaporation-condensation unit (2), partially evaporating a part of the feed (3) at the evaporation frames (9) within the unit (2) and generating vapor (4) and passing the generated vapor (4) from the evaporation frames (9) of the unit (2) to a suction side of a mechanical vapor recompressor (MVR) mounted externally to the evaporation-condensation unit. The generated vapor (4) enters the suction side of a mechanical vapor recompressor (MVR) at a vapor outlet (B).

In the mechanical vapor recompressor unit, the generated vapor (4) is compressed to a higher pressure and temperature, ideal isotropic vapor and passed to the frames for condensation. The method further comprises of feeding back the compressed vapor (7) with the high pressure and temperature at an upper inlet (D) of the evaporation-condensation unit (2) from the mechanical vapor recompressor (8) and passing the compressed vapor (7) to condensation frames (5) separated by the polymer sheet (6) from evaporation frames (9) and the mechanical vapor recompressor (8) for condensation. The compressed vapor (7) condenses in the condensation frames (5) placed opposite to the evaporation frames (9) and heats up the inflowing feed or solution, and forms distillate (10) and concentrate (14). The distillate from the evaporation-condensation unit (2) is collected at a distillate outlet (E) and the concentrate (14) from the evaporation-condensation unit (2)) is collected at a concentrate outlet (C). The method is performed at a pressure level ranging from a positive pressure to a negative pressure and at a temperature ranging from above 100° C. to temperatures far below 100° C. for the process of evaporation and condensation. In present embodiment of the disclosure, the working temperature of the method ranges from 5° C. to 160° C. and the working pressure ranges from 8 mbara to 6.2 bara. The pressure levels indicated here in bara are absolute pressures in bar. In a preferred embodiment of the present disclosure, the working temperature of the method ranges from 40° C. to 130° C. and the working pressure ranges from 73.75 mbara to 2.70 bara.

The method may further comprise of separating the droplets from the vapor (4) by passing the generated vapor (4) to a droplet separator (19) integrated within the evaporation-condensation unit (2). The droplet separator (19) comprises a stack of frames separated by membranes (18). The stack of frames comprise droplet separation frames (17) for collecting separated droplets and a clean vapor frame (16) for collecting droplet free vapor. At the droplet separator (19), microporous hydrophobic membranes (18) hold back the droplets from the generated vapor (4) and droplet free vapor is generated and passed to a suction side of the recompressor (8) for compression and condensation.

The Non-Condensable Gases (NCGs) become free when the feed is heated up and NCGs are flowing with the vapor into the frame for condensation. To avoid NCGs from the vapor that the NCGs are trapped in the frame for condensation, when NCGs are flowing via the distillate channel to the ambient. NCGs may be pumped out of the evaporation-condensation unit by a vacuum unit. The vacuum unit also creates the process pressure in the evaporation-condensation unit.

The present invention discloses the system for evaporator and condensation based on polymer films arranged in a way to be used for evaporation and condensation processes. The present disclosure provides individual frames built for evaporation and condensation, offering a single solution to overcome the disadvantages of the conventional evaporation and condensation systems and methods. It is ideal to build up the evaporator and condenser of an MVR with frames. Utilizing polymeric materials, especially thermoplastic materials make the application universal in terms of material compatibility. Further, the present disclosure provide a low cost solution as polymers are cheap, no high-grade steels or titanium materials are used, and high volume mass production of polymers are possible using industrial production methods. The disclosed systems are used for variety of applications such as for Wastewater concentration, Desalination, Process concentration and other Thermal separation requirements.

The above description along with the accompanying drawings is intended to disclose and describe the preferred embodiments of the invention in sufficient detail to enable those skilled in the art to practice the invention. It should not be interpreted as limiting the scope of the invention. Those skilled in the art to which the invention relates will appreciate that many variations of the exemplary implementations and other implementations exist within the scope of the claimed invention. Various changes in the form and detail may be made therein without departing from its spirit and scope. Similarly, various aspects of the present invention may be advantageously practiced by incorporating all features or certain sub-combinations of the features.

We claim:

1. A system for evaporation and condensation, the system (1) comprising:
at least one evaporation-condensation unit (2) comprising a plurality of frames arranged in a series of stacks, each stack comprises:
an evaporation frame (5); and
a condensation frame (9) separated by a polymer sheet (6) from the evaporation frame (5), wherein the at least one evaporation-condensation unit (2) is a partially flooded sealed unit comprising a lower inlet (A), a vapor outlet (B), a concentrate outlet (C), an upper inlet (D) and a distillate outlet (E), the unit (2) receives a feed (3) at the lower inlet (A) and a part of the feed (3) partially evaporates at the evaporation frame (9) and generates vapor (4);
a mechanical vapor recompressor (8) mounted outside the at least one evaporation-condensation unit (2) receiving the generated vapor (4) from the at least one evaporation-condensation unit (2) at a vapor outlet B and feeding back the vapor (4) with high pressure and temperature to the at least one evaporation-condensation unit (2) at an upper inlet D;
wherein each frame is made of a polymer material and a plurality of frames are detachably integrated within the at least one evaporation-condensation unit (2).

2. The system as claimed in claim 1, wherein the system (1) further comprises a plurality of heat exchangers coupled with the at least one evaporation-condensation unit (2).

3. The system as claimed in claim 2, wherein the plurality of heat exchangers comprise a first heat exchanger (11) mounted with the concentrate outlet (C) for heating the feed (3) by transferring heat from the concentrate (14).

4. The system as claimed in claim 2, wherein the plurality of heat exchangers comprise a second heat exchanger (12) mounted with the distillate outlet (E) for hearing the feed (3) by transferring the heat from the distillate (10).

5. The system as claimed in claim 2, wherein the plurality of heat exchangers comprise a third heat exchanger (13) mounted with the lower inlet (A) for heating the feed (3) during a startup phase.

6. The system as claimed in claim 1, wherein the system further comprises a droplet separator (19) detachably attached to the at least one evaporation-condensation unit.

7. The system as claimed in claim 1, wherein the droplet separator (19) is configured to receive vapor (4) from the evaporation-condensation unit.

8. The system as claimed in claim 6, wherein the droplet separator (19) comprises a stack of frames separated by membranes.

9. The system as claimed in claim 6, wherein the stack of frames comprise droplet separation frames (17).

10. The system as claimed in claim 8, wherein the membrane is a microporous hydrophobic membrane.

11. The system as claimed in claim 1, wherein the series of stacks arranged in a repeated pattern.

12. The system as claimed in claim 1, wherein the series of stacks are arranged in an alternative pattern.

13. The system as claimed in claim 1, wherein the polymeric sheet is made of materials selected from Polypropylene (PP), Polyvinyl chloride (PVC) or Polyvinylidene fluoride (PVDF).

14. The system as claimed in claim 1, wherein the polymer sheet has a thickness in a range from 10 μm to 40 μm.

15. The system as claimed in claim 1, wherein at least two evaporation-condensation units are arranged in series with a mechanical vapor recompressor (8) forming a multi-effect system for evaporation and condensation.

16. The system as claimed in claim 1, wherein at least two evaporation-condensation units are integrally mounted in series within a sealed unit forming a multi-effect system for evaporation and condensation.

17. The system as claimed in claim 1, wherein the multi-effect system comprises a plurality of orifices (M, N) enabling the flow of condensate (10) and feed (3) respectively from one evaporation-condensation unit to another evaporation-condensation unit.

18. A method for evaporation and condensation, the method comprising:
passing a feed (3) through at least one evaporation-condensation unit (2) at a lower inlet (A), wherein the evaporation-condensation unit comprises a plurality of frames arranged in a series of stack, each stack comprises an evaporation frame (5) and a condensation frame (9) separated by a polymer sheet (6);
distributing the feed to the evaporation frames (9) of the evaporation-condensation unit (2);
partially evaporating a part of the feed (3) at the evaporation frames (9) within the unit (2) and generating vapor (4);
passing the generated vapor (4) at a vapor outlet (B) to a mechanical vapor recompressor (8) mounted outside the evaporation-condensation unit (2) for compression;
feeding back the compressed vapor (7) with the high pressure and temperature at an upper inlet (D) of the evaporation-condensation unit (2) from the mechanical vapor recompressor (8);
passing the compressed vapor (7) to condensation frames (5) separated by the polymer sheet (6) from evaporation frames (9) and the mechanical vapor recompressor (8) for condensation;
forming a distillate (10) and concentrate (14) by condensing the compressed vapor (7) at the condensation frames (5) placed opposite to the evaporation frames (9) and
collecting the distillate from the evaporation-condensation unit (2) at a distillate outlet (E) and the concentrate (14) from the evaporation-condensation unit (2) at a concentrate outlet (C);
wherein each frame is made of a polymer material and a plurality of frames are detachably integrated within the evaporation-condensation unit (2).

19. The method as claimed in claim 18, wherein the method further comprises of heating the feed (3) by transferring heat from the concentrate to the feed by a first heat exchanger (11) mounted with the concentrate outlet (C).

20. The method as claimed in claim 18, wherein the method further comprises of heating the feed (3) by transferring heat from the distillate to the feed by a second heat exchanger (12) mounted with the distillate outlet (E).

21. The method as claimed in claim 18, wherein the method further comprises of heating the feed during a startup phase by a third heat exchanger (13) mounted with the lower inlet (A).

22. The method as claimed in claim 18, wherein the method further comprises of separating the droplets from the vapor (4) by passing the vapor (4) to a droplet separator (19), wherein the droplet separator (19) is detachably attached to the evaporation-condensation unit (2).

23. The method as claimed in claim 22, wherein the droplet separator (19) comprises a stack of frames separated by membranes (18), wherein the stack of frames comprise droplet separation frames (17) for collecting separated droplets and a clean vapor frame (16) for collecting droplet free vapor.

24. The method as claimed in claim 22, wherein droplet free vapor is generated at the droplet separator (19) and the droplet free vapor is passed to a suction side of the recompressor (8).

25. The method as claimed in claim 23, wherein the membranes (18) hold back the droplets from the generated vapor (4).

26. The method as claimed in claim 23, wherein the membrane is a microporous hydrophobic membrane.

27. The method as claimed in claim 18, wherein the method further comprises of passing the feed through at least two evaporation-condensation units arranged in series with a mechanical vapor recompressor (8) for a multi-effect evaporation and condensation.

28. The method as claimed in claim 18, wherein the method is operated at a pressure level ranging from 73.75 mbara to 2.70 bara.

29. The method as claimed in claim 18, wherein the method is operated at a temperate level ranging from 40° C. to 130° C.
